(19) United States
(12) Patent Application Publication
(10) Pub. No.: US 2025/0259145 A1
(43) Pub. Date: Aug. 14, 2025

(54) ENTERPRISE CONTENT MANAGEMENT WITH CONTEXTUAL FUNCTIONALITY INCLUDING INTEGRATION WITH AUTOMOTIVE MEDIA SYSTEMS AND ASSOCIATED CONTEXTUAL FUNCTIONALITY

(71) Applicant: Open Text Holdings, Inc., Menlo Park, CA (US)

(72) Inventors: Pankaj Shrivastava, Bangalore (IN); Rakesh Agarwal, Bangalore (IN); Sharad Kumar, Bangalore (IN)

(21) Appl. No.: 18/436,852

(22) Filed: Feb. 8, 2024

(51) Int. Cl. G06Q 10/109; B60K 35/22; B60K 35/26; G06F 3/16

(52) U.S. Cl. CPC G06Q 10/109; B60K 35/22; B60K 35/26; G06F 3/16

(57) ABSTRACT

Embodiments of systems and methods for Enterprise Content Management (ECM) systems including ECM mobile applications that can tailor offered functionality based on an operating context of the ECM mobile application are disclosed. In particular, embodiments as disclosed may tailor workflow functionality offered by an ECM mobile application based on the operation of that ECM mobile application in an automotive media environment where the ECM application is connected to a car infotainment system using an automotive media interface.

### TECHNICAL FIELD

This disclosure relates generally to the field of content management. More particularly, this disclosure relates to providing contextual functionality for enterprise content management systems. Even more specifically, this disclosure relates to integration of enterprise content management systems with automotive or other mobile media systems and the implementation and use of contextual functionality in association with such integration.

### BACKGROUND

Content management refers to the creation and modification of digital content (also referred to simply as content, electronic documents, or just documents). A content management system refers to a computer system that can be used to create, modify, or otherwise manage interactions with, and uses of, digital content. Recently, enterprise-class content management (ECM) systems have been utilized to provide such content management services, along with other associated services, to what may be large and highly distributed enterprises. These ECM systems may provide many features in addition to traditional management of digital content, such as process management (e.g., workflow) federation, migration, security, content governance, fault tolerance, etc. in association with the digital content maintained by these systems.

Accordingly, the use of ECM systems has been woven into the very fabric of users' working lives. As such, these users' ability to access ECMs is being constantly expanded. This expansion of access has only grown with the increased desire, interest, and necessity of providing a remote work infrastructure for employees. Consequently, many of these ECM systems include mobile applications or “apps” that have been developed to allow users to access functionality of the ECM system through their mobile devices. In other words, a user may install a mobile application associated with the ECM system on their mobile device and access the content and functionality of that ECM through that mobile application.

While beneficial from an accessibility standpoint, the use of these mobile applications for ECM systems is not without its issues. Specifically, the very nature of mobile devices means that these devices may be utilized or accessed in contexts where it is not possible, or desirable, to interact in certain manners with the ECM system, or where adequate attention or time may not be available to devote to such interactions with an ECM mobile application.

Thus, it may be desired to seamlessly integrate the use of these ECM mobile applications into certain contexts where mobile devices may be utilized. Moreover, it may be desirable to tailor the functionality of these ECM mobile applications to the context in which they are being utilized, including offering (or not offering) certain functionality in an ECM mobile application based on the context in which the mobile application is being utilized or the mobile device is otherwise being utilized.

### SUMMARY

Continuing with the above discussion, it may be desired to seamlessly integrate the use of ECM mobile applications into certain contexts where mobile devices may be utilized. Moreover, it may be desirable to tailor the functionality of these ECM mobile applications to the context in which they are being utilized, including offering (or not offering) certain functionality in an ECM mobile application based on that context.

To address these desires, among other ends, embodiments as disclosed herein may tailor the functionality provided by an ECM mobile application to a context where the mobile device is being utilized. Specifically, embodiments of an ECM mobile application may obtain a context in which the mobile application is being utilized. For example, one particular context in which mobile applications are often utilized is while driving (e.g., or otherwise traveling in an automobile or other mode of conveyance). According to an embodiment, therefore, when a mobile device is being utilized in an automotive context, and the mobile device is connected to a car's infotainment system, an ECM mobile application may detect that the ECM mobile application is being utilized in an automotive context.

Once the context of operation of the mobile device or mobile application is obtained, embodiments of the ECM mobile application on the mobile device can tailor offered functionality based on this obtained context. One aspect of this tailoring of functionality offered by the mobile application may be related to a type of interaction offered by the mobile application. For example, when the obtained context indicates the mobile application is being utilized in an automotive context, the mobile application may offer audio (e.g., voice based) interaction. The mobile application can also present an audio interface whereby the interface is presented auditorily through the car's infotainment system.

Another aspect of tailoring of the functionality offered by embodiments of a mobile application may be related to the functionality of the mobile application that is provided or offered (or not provided or offered) though the interfaces of the ECM mobile application. To illustrate in more detail, one of the main functionalities involved with modern ECM systems is providing the functionality of a workflow system. Embodiments as discussed herein may thus tailor functionality offered in association workflow systems to an automotive environment. Specifically, embodiments may offer workflow functionality in association with workflow tasks where the offered functionality is tailored to the automotive context. The offered functionality may for example, be available only in the automotive context or may not include functionality normally available in association with those tasks in a non-automotive context.

For example, in certain embodiments, the functionality offered may be based on a workflow task requiring an approval by the user and the context of the automotive operation. In such cases, a soft approval may be offered for the task, where such a soft approval may be registered in association with the task allowing the workflow associated with the task to proceed while, in some cases, having the task remain on that user's task list (e.g., without the user having issued an approval or otherwise having completed that action for that task).

Other functionality may also be offered by embodiments of an ECM mobile application based on operation in an automotive context, including, for example, offering a user the ability to add a reminder to revisit the workflow task or functionality that invokes or utilizes other functionality or applications provided by the mobile device. For example, the ECM mobile application may also offer the user the ability to call or message an assigner associated with a task or to call or message assigners or assignees of other tasks within the workflow.

As embodiments of ECM mobile applications as disclosed may offer context relevant modes of interaction and functionality, these ECM mobile applications, and ECM systems including these ECM mobile applications, may offer a number of advantages. As one advantage, by tailoring the functionality offered, or mode of interaction, to the context in which the mobile application is being utilized (e.g., in an automotive contexts), embodiments may allow ECM systems to be accessed and utilized in contexts where such ECM functionality was not previously available. Moreover, embodiments may allow efficacy to be gained in the performing ECM in such contexts by tailoring the functionality and modes of interaction to the context to include modes and functionality that are only available in that context that allow ECM functionality to be successfully accessed and utilized in such contexts despite the constraints that such contexts may impose, including for example, constraints related to a user's ability to perform workflow tasks.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, and/or rearrangements may be made within the scope of the disclosure without departing from the spirit thereof, and the disclosure includes all such substitutions, modifications, additions, and/or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 depicts a diagrammatic representation of a distributed computing environment including an ECM system.

FIG. 2 depicts one example of an API for setting a location based reminder.

FIG. 3 depicts one example of the setting of a location based reminder.

FIG. 4A depicts a diagrammatic representation of an architecture for tailoring ECM functionality of a mobile application in an automotive media environment.

FIGS. 4B-1 and 4B-2 depict a flow diagram for an embodiment of a method for tailoring workflow related functionality of an ECM mobile application in an automotive media environment.

FIGS. 5A and 5B depict an example for a declaration for an ECM mobile application.

FIG. 5C includes an example of a definition of an automotive interface service.

FIG. 5D depicts one example of a manifest file including a task service.

FIG. 5E includes an example of a definition of task service.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions, and/or rearrangements within the spirit and/or scope of the underlying inventive concept will become apparent to those skilled in the art from this disclosure.

As discussed an enterprise-class content management (ECM) system may provide content management services, along with other associated services, to what may be large and highly distributed enterprises. These ECM systems may provide many features in addition to traditional management of digital content, such as process management (e.g., workflow) federation, migration, security, content governance, fault tolerance, etc. in association with the digital content maintained by these systems.

The ability for users to access ECMs is being constantly expanded. One of the mechanisms utilized to expand this access has been the use of mobile applications. By installing a mobile application on their mobile device a user may access functionality of the ECM system through their mobile device. These mobile devices may, however, accompany users at substantially all times. Including while engaged in driving or in other contexts where adequate attention or time may not be available, or where it may be less than desirable, to devote to such interactions with an ECM mobile application.

For example, in many cases, a user may not wish to fully engage with a ECM mobile application on their mobile device while driving or while in a social setting. Thus, it may be desired to seamlessly integrate the use of these ECM mobile applications into certain contexts where mobile devices may be utilized. Moreover, it may be desirable to tailor the functionality of these ECM mobile applications to the context in which they are being utilized, including offering (or not offering) certain functionality in an ECM mobile application based on the context in which the mobile application is being utilized or the mobile device is otherwise being utilized.

To those ends, among others, embodiments as disclosed herein may tailor the functionality provided by an ECM mobile application to a context where the mobile device is being utilized. Specifically, embodiments of an ECM mobile application may obtain a context in which the mobile application is being utilized. This context may be, for example, be determined based on a user or device level setting, such as silencing the mobile device or turning on a do not disturb setting for the device, or may be determined based on a user interaction with the mobile application itself, such as by setting a context in a menu offered by the mobile application. The context may also be detected based on a state of operation of the mobile application or mobile device.

For example, one particular context in which mobile applications are often utilized is while traveling. Specifically, mobile applications are often utilized while driving (e.g., or otherwise traveling in an automobile or other mode of conveyance). In fact, many manufacturers of mobile devices have provided mobile interface standards by which an infotainment system in a vehicle (e.g., a car head unit) may act as a controller for the mobile device. Apple CarPlay® and Android Auto® are examples of such mobile interface standards. The automobile's infotainment system can thus implement the standard and provide a mobile application connectivity to the car's infotainment system. Accordingly, by using mobile interface standards, when the mobile device is connected to the car's infotainment system the infotainment system may present a mobile application, and allow interactions with the mobile application through the car's infotainment system. Consequently, when a mobile device is being utilized in an automotive context, and the mobile device is connected to a car's infotainment system, an ECM mobile application may detect that the ECM mobile application is being utilized in an automotive context.

Once the context of operation of the mobile device or mobile application is obtained, embodiments of the ECM mobile application on the mobile device can tailor offered functionality based on this obtained context. One aspect of the tailoring of functionality offered by the mobile application may be related to the type of interaction offered by the mobile application. For example, when the obtained context indicates the mobile application is being utilized in an automotive context (e.g., the mobile application detects it is operating in a mobile interface environment and linked to a car infotainment system using a mobile interface standard), the mobile application may enable certain modes of interaction. One mode of interaction in this context can be an audio interaction including enabling voice recognition whereby a user can issue voice commands to the ECM mobile application and the ECM mobile application will process and recognize such voice interactions (or not recognize the voice interaction) and respond accordingly. The mobile application can also present an audio interface whereby the interface is presented auditorily through the car's infotainment system.

Another aspect of tailoring the functionality offered by the mobile application may be related to the functionality of the mobile application that is provided or offered (or not provided or offered) though the interfaces of the ECM mobile application. To illustrate in more detail, one of the main functionalities involved with modern ECM systems is providing the functionality of a workflow system. A workflow system may provide an infrastructure for the set-up, performance, monitoring or tracking of a defined sequence of tasks arranged as a workflow application or process. A workflow system thus allows a user to define different workflows that may relate to, for example, different types of content, jobs, or processes. For instance, in a manufacturing setting, a design document might be automatically routed from a designer to a technical director for approval and from the technical director (when approved) to the production engineer for technical review. At each stage in the workflow, one individual or group is responsible for a specific task (e.g., approval or technical review in the previous example). Once that task is complete, a workflow system ensures that the entity (e.g., individual) responsible for the next task is notified (e.g., electronically) and can access the data (e.g., the content) they need to execute their stage of the process (e.g., their task).

A user can thus access the ECM system (e.g., through the mobile application on the user's mobile device) to be notified of, access, and complete, workflow tasks that have been assigned to them. Typical tasks that may be completed at each stage of a workflow may be to accept tor approve (e.g., content, or a portion thereof), add a note (e.g., to content), change a priority of a task, or assign or delegate the task, mark content as reviewed or read, among other types of tasks.

Interfaces of a workflow system (e.g., an ECM system being utilized to implement a workflow, including mobile applications for these ECM systems) are thus adapted to present a user with tasks that have been assigned to that user and facilitate the completion of those tasks by the user.

As some of these tasks require a not insignificant amount of time, attention, or effort (e.g., they may require reading or editing a document), it is often the case that a user cannot complete (or fully complete) an assigned task for a workflow because of the context in which they are accessing the ECM system. To continue with the above scenarios, when a user is engaged with their ECM mobile application while driving or when in a social setting the user may not have the time or attention to devote to completing a task (e.g., without endangering themselves such as when driving), or does not desire to devote the time or attention to completing the task (e.g., in social settings a user may rather engage socially or avoid being rude by ignoring their companions to focus on their mobile device).

This situation may be problematic, especially in a workflow environment. Recall that tasks are usually completed at each stage of a workflow where those tasks and stages may involve different users. Because of the nature of workflows, if a particular user cannot complete a task that entire workflow may be paused until such a time as that user does have adequate attention or time to complete the task. It is only at the point where that user does complete the assigned task that the next stage of the workflow may be started. Thus, a user's inability to accomplish a task (e.g., because of the context in which they are interacting with the ECM system) may severely impact the ability to accomplish workflows expeditiously as the next stage of the workflow cannot be commenced until the user completes that task. As mentioned, however, the context in which a user is interacting with the ECM mobile application may constrain the ability of the user to complete their tasks in a timely manner. Moreover, these contexts may persist for quite lengthy time periods (e.g., a user may be driving a long distance).

To address this situation, embodiments of ECM systems as disclosed may provide a mobile application that can tailor the functionality of the mobile application that is provided or offered (or not provided or offered) though the interfaces of the ECM mobile application based on a detected context for the ECM mobile application. In particular, the functionality offered in association with the user's tasks may be tailored to a detected context, where that functionality offered for tasks may differ based on context such that the functionality offered in certain contexts (e.g., when it is detected the mobile application is operating in an automotive context) may be different from, a superset of, or a subset of, functionality offered in other contexts or in normal operation of the mobile application (e.g., when a particular operating context is not detected by the mobile application). In some cases, the functionality offered by the ECM mobile application for a task assigned to a user in a given context may be based on the type of that task.

As but one example, when an instance of an ECM mobile application detects it is operating an automotive environment (e.g., that mobile device on which the ECM mobile application is executing is connected to a car's infotainment system or is using functionality associated with a mobile interface environment) the ECM mobile application (e.g., through interface thereof) may offer the user functionality of providing a soft approval for a task. This functionality may be offered based on the task requiring an approval by the user and the context of the automotive operation. A soft approval may be registered with the ECM system in association with the task allowing the workflow associated with the task to proceed while, in some cases, having the task remain on that user's task list (e.g., without the user having issued an approval or otherwise having completed that action for that task).

The ECM mobile application may also offer the user the ability to add a reminder to revisit the task. This reminder may be associated with the task and stored in a calendar on the user's mobile device, a calendar associated with the ECM system or a third party calendaring service (e.g., Google® Calendar). This reminder may be set for a specific time or for a specific location (e.g., home, work, the user's office or another location saved in a user's map application on their mobile device). In this manner, location based services may be utilized to determine a user's location and provide the reminder to a user based on such a location. To implement such a location based reminder, the ECM mobile application may utilize an interface provided by a third party calendaring service based on a user's information to add a calendar entry to the user's calendar where that entry comprises a location based reminder and data regarding the task.

Other functionality may be provided through the interface of the ECM mobile application, including functionality that invokes or utilizes other functionality or applications provided by the mobile device. For example, the ECM mobile application may also offer the user the ability to call (e.g., conduct a voice conversation with), or message (e.g., send a text message) to an assigner associated with a task or to call or message assigners or assignees of other tasks within the workflow. To facilitate this functionality the ECM mobile application may access the task or the workflow as provided by an ECM server of the ECM system to determine an assigner of the task or assigners or assignees of other tasks of the workflow and access the contact list on the mobile device to determine contact information (e.g., a phone number) for those assigners or assignees). The ECM mobile application can then use the calling or messaging functionality on the mobile device to call or message those assigners or assignees if the user indicates that they desired to invoke such functionality.

As embodiments of ECM mobile applications as disclosed may offer context relevant modes of interaction and functionality, these ECM mobile applications, and ECM systems including these ECM mobile applications, may offer a number of advantages. As one advantage, by tailoring the functionality offered, or mode of interaction, to the context in which the mobile application is being utilized (e.g., in an automotive contexts), embodiments may allow ECM systems to be accessed and utilized in contexts where such ECM functionality was not previously available. Moreover, embodiments may allow efficacy to be gained in the performing ECM in such contexts by tailoring the functionality and modes of interaction to the context to include modes and functionality that are only available in that context that allow ECM functionality to be successfully accessed and utilized in such contexts despite the constraints that such contexts may impose, including for example, constraints related to a user's ability to perform workflow tasks.

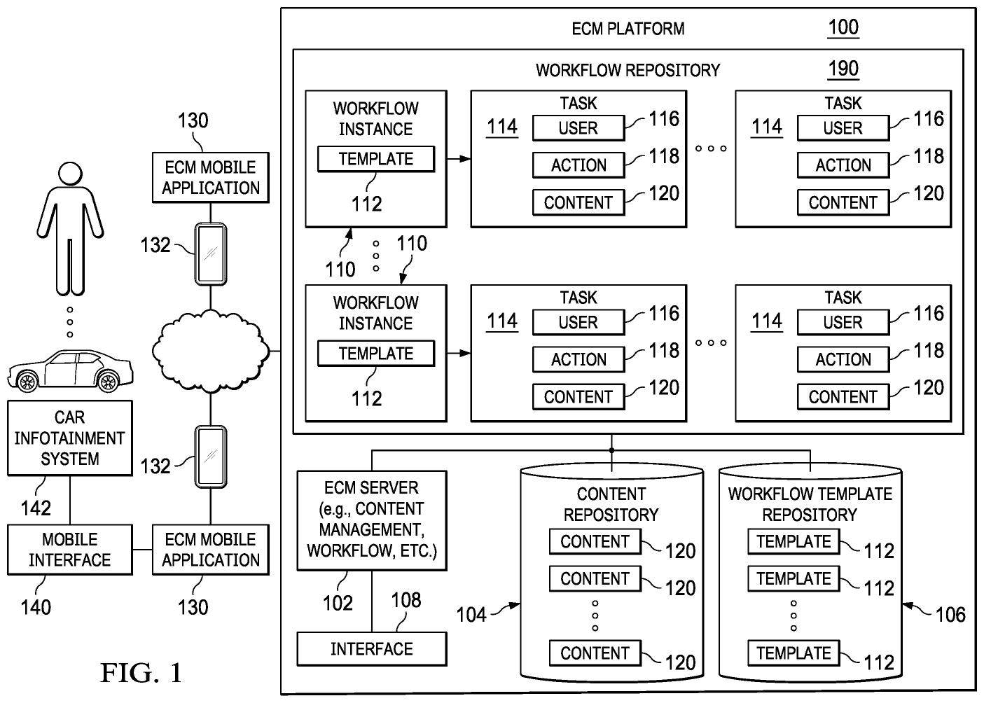

Turning then to FIG. 1, a diagrammatic representation of a distributed computing environment including one embodiment of an ECM system. An ECM system can provide content management, workflow, and other associated capabilities for all types of content. In the example of FIG. 1, ECM platform 100 includes ECM server 102 configured with modules for the functionalities of ECM server 102 (e.g., content management, workflow, federation, migration, log purge, filescan, audit-trail, job scheduler, method launcher, audit purge, replication, etc.). The functionality of the ECM server 102 may be accessed through interface 108 which may be, for example, an Application Programming Interface (API), REST interface or another type of interface.

The ECM platform 100 may also include content repository 104. Content repository 104 may include content managed by the ECM system. For example, content repository 104 can be a repository in which the content is stored securely under compliance rules in a unified environment, although content may reside on multiple servers or physical storage devices within a networked computing environment.

The ECM system may provide the functionality of a workflow system and be adapted to provide an infrastructure for the set-up, performance, monitoring or tracking of a defined sequence of tasks arranged as a workflow application or process. It will be noted at this point that while embodiments as presented herein will be described with respect to an ECM system that provides workflow functionality, these or other embodiments may be effectively utilized with any type of computing system that provides workflow functionality, and all such embodiments are fully contemplated herein.

An ECM system having workflow functionality may thus allow a user to define different workflows that may relate to, for example, different types of content, jobs, or processes. Accordingly, ECM platform 100 may also include workflow template repository 106. Workflow template repository 106 includes templates 112 for defined workflows that may be utilized to create workflow instances. These workflow templates may have been designed in a workflow designer or configured in an administrative application and provided to ECM platform 100 for use in implementing workflows.

The ECM system may utilize these workflow templates to create workflow instances 110 which are dynamic instances of workflow processes as defined by those workflow templates. Each of these workflow instances may be maintained in workflow repository 190. Each workflow instance 110 may be associated with a corresponding workflow template 112 and comprise a set of workflow tasks 114 (referred to herein also as tasks). Each of the tasks 114 of a workflow instance may be associated with a user 116 to perform that task 114, an action 118 that the user 116 may be required or requested to perform for the task 114, or content 120 associated with that task 114. It will be observed that tasks 114 of a workflow instance 110 may be dynamically determined, added, or removed based on a state of the workflow instance 110, the outcome of previous tasks 114, the corresponding workflow template, or other factors. For example, it may be the case that there is only a single active, current, or next task 114 associated with the workflow instance 110 and, based on the outcome of that active task 114, a subsequent task 114 may be determined, associated with workflow instance and made the active, current or next task 114 associated with the workflow instance 110. Alternatively, a set of tasks 114 may be defined for the workflow instance 110 and a status maintained for workflow instance 110 indicating which task 114 is active. Other arrangements are possible and are fully contemplated herein.

The ECM system may also include ECM mobile application (or just mobile application) 130. Such a mobile application 130 may be an application installed on a mobile device 132 such as a smartphone, tablet device, or other mobile computing device. Users of such mobile applications 130 may access functionality of the ECM system through interface 108 of ECM platform 100. Thus, a user at a mobile device 132 may interact with the mobile application 130 which (e.g., after the user is authenticated) communicates with interface 108 of ECM platform 100 to allow ECM functionality provided by ECM platform 100 to be accessed by the user through the mobile application. For example, in the context of workflow functionality, a user using mobile application 130 on his mobile device 132 may access the ECM platform 100 using mobile application 130. The mobile application 130 may request tasks 114 associated with that user. The request can be received through interface 108 at the ECM platform 100 and based on this request, the ECM server 102 can determine tasks 114 associated with the user. The ECM server 102 can also determine actions for that user in association with those determined tasks 114. The determined actions may be based on action 118 associated with the task 114 determined for the user. These tasks 114 and actions can then be returned to the mobile application 130. Upon receiving those tasks 114 the mobile application 130 may present those tasks 114 to the user through the user interface of mobile application 130. The user can then (if desired) select task 114 and take an action with respect to that task 114. The action taken can then be communicated back to the ECM platform 100 through interface 108 and used to update the task 114 or workflow instance 110 associated with that task 114.

Mobile application 130 may often be utilized while driving (e.g., or otherwise traveling in an automobile or other mode of conveyance). Many manufacturers of mobile devices 130 have provided mobile interface standards by which an infotainment system in a vehicle (e.g., a car head unit) may act as a controller for the mobile device. CarPlay® and Android Auto® are examples of such mobile interface standards. The automobile's infotainment system can thus implement the standard using mobile interface 140 and provide mobile application 130 connectivity to the car's infotainment system 142. Accordingly, by using mobile interface 140 when a user's mobile device 132 is connected to the car's infotainment system 142 through mobile interface 140 the infotainment system 142 may present mobile application 130, and allow interactions with the mobile application 130 through the car's infotainment system 142. Consequently, when a mobile device 132 is being utilized in an automotive context, and the mobile device 132 is connected to a car's infotainment system 142, ECM mobile application 130 may detect that the ECM mobile application is being utilized in an automotive context.

Once the context of operation of the mobile application 130 is determined, embodiments of the ECM mobile application 130 on the mobile device 132 can tailor the functionality based on its operation in an automotive context. In one case, the interface of the mobile application 130 may be tailored to the automotive context by enabling voice recognition whereby a user can issue voice commands to the ECM mobile application 130 and the ECM mobile application 130 will process and recognize such voice interactions (or not recognize the voice interaction) and respond accordingly through an audio response through the car's infotainment system 142. In particular, mobile application 130 may have a messaging service that interfaces with car's infotainment system 142. Thus, the messaging service can receive voice issued commands through the car infotainment system 142, process the verbally issued command to recognize the voice command, and call an appropriate interface of mobile application 130 associated with the recognized command. The messaging service can also receive responses to such calls and present these responses auditorily though the car's infotainment system 142.

Thus, when the user's mobile device 132 is coupled to the car's infotainment system 142 through the mobile interface 140, a user may access workflow functionality of ECM system provided by ECM platform 100 through voice commands issued to the mobile application 130 through the car's infotainment system 142. For example, the mobile application 130 may obtain a task 114 associated with the user (e.g., assigned to the user). This task 114 may be obtained as a result of a notification sent by ECM platform 100 to the mobile application 130, or may be a result of a user verbally requesting a list of tasks through the car's infotainment systems 142, mobile application 130 recognizing that verbal command, and mobile application 130 requesting these tasks 114 for the user through interface 108 of ECM platform 100. The tasks 114 can then be auditorily presented to the user by through the interface of mobile application 130 through the car's infotainment system 142 (e.g., one or more of the tasks 114 received by the mobile application 130 may be “read” or “announced” to the user by the interface of the mobile application 130 through the car's infotainment system 142).

A user may then choose to interact with a (auditorily) presented task 114 by issuing a verbal command specifying a task 114 and a desire to act with respect to that task. This verbal command may be received through the car's infotainment system 142 and ECM mobile application 130 may process and recognize this voice interaction to act on a task 114. Based on this voice issue command, mobile application 130 may issue a request to interface 108 of ECM platform 100. The interface 108 selected for the request may be associated with operation in automotive context, such that requests for a particular service at that interface may be associated with (or otherwise determined to be indicators of) operation of the mobile application 130 in an automotive context. The request may, for example, be for actions associated with one or more tasks 114 and specify (e.g., include an identifier for) a user, a task, a workflow instance, or other pertinent information. The request may also indicate that the mobile application 130 is operating in an automotive context. Alternatively or additionally, interface 108 provided by ECM platform 100 may include one or more interfaces (e.g., URLs, commands, APIs, etc.) specific to an automotive context. Thus, mobile application 130 may utilize such interfaces when operating in such an automotive context.

This request can be received through interface 108 at the ECM platform 100 and based on this request, the ECM server 102 can determine actions for that user in association with the one or more tasks 114. The determined actions may be based on action 118 associated with the task 114. In particular, the actions offered in association with the user's tasks 114 may be tailored to the automotive context, and in some cases may be actions only available (e.g., for that task) when the mobile application 130 is operating in an automotive context (or another type of context where limited time or attention may be available). In some cases, there may be a mapping between actions 118 associated with a task 114 (e.g., that a user is required to perform) and actions that may be determined for that task by the ECM based on the automotive context in which mobile application 130 is operating. For example, if an action 118 associated with a task is an approval, an action determined for the task 114 may be a soft approval for the task 114. Another action determined for task 114 may be to add a reminder to revisit the task 114. Other actions for a task may include calling (e.g., conduct a voice conversation with), or message (e.g., sent a text message) to an assigner associated with a task or to call or message assigners or assignees of other tasks 114 within the workflow instance 110. These determined actions for the one or more tasks 114 can then be returned to the mobile application 130. In one embodiment, these actions may be stored at a cache associated with the mobile application 130 at the mobile device 132.

The actions for the task can then be auditorily presented to the user by through the interface of mobile application 130 through the car's infotainment system 142 (e.g., one or more of the actions received by the mobile application 130 may be “read” or “announced” to the user by the interface of the mobile application 130 through the car's infotainment system 142). A user may then select a (auditorily) presented action through the car infotainment system 142 by issuing a verbal command specifying the desired action.

This verbal command for that action may be received through the car's infotainment system 142 and ECM mobile application 130 may process and recognize this voice interaction. For example, the messaging service of the ECM mobile application 130 can receive the voice command specifying the actions, process the verbally issued command to recognize the voice command, and call an appropriate interface of mobile application 130 or ECM platform 100 associated with the recognized command and action.

For example, if a user selects a soft approval action, the ECM mobile application 130 may send a request to interface 108 of ECM platform 100 associated with a soft approval indicating a soft approval of task 114. This request may, for example, specify (e.g., include an identifier for) the user, the task 114, the workflow instance 110, or other pertinent information. When ECM platform 100 receives such a request for a soft approval, ECM platform 100 may register the soft approval with the corresponding task 114 and user 116. Accordingly, workflow instance 110 associated with task 114 that was soft approved may be allowed to proceed to a subsequent stage. In some cases, task 114 that was soft approved may remain on that user's task list. Thus, an action 118 associated with the task 114 at the ECM platform 100 may be an approval associated with content 120 and a soft approval action may be determined for that task, whereby if a user takes that soft approval action the workflow instance 110 associated with that task 114 may be allowed to proceed to a subsequent task 114 at the ECM platform 100 (e.g., the workflow instance 110 may continue processing without the user approving associated content).

The user may also select an action to add a reminder to revisit the task. In response to receiving a command selecting such an action, mobile application 130 may access a calendaring application on the mobile device 132 and store a reminder (e.g., a calendar entry) specifying the task 114 in the calendar. The reminder may include a link to the task (e.g., at the ECM platform 100) or content repository 104 related to the task 114. The mobile application may also send a request to interface 108 of ECM platform 100 to store such a reminder in a calendar of the user associated with the ECM system.

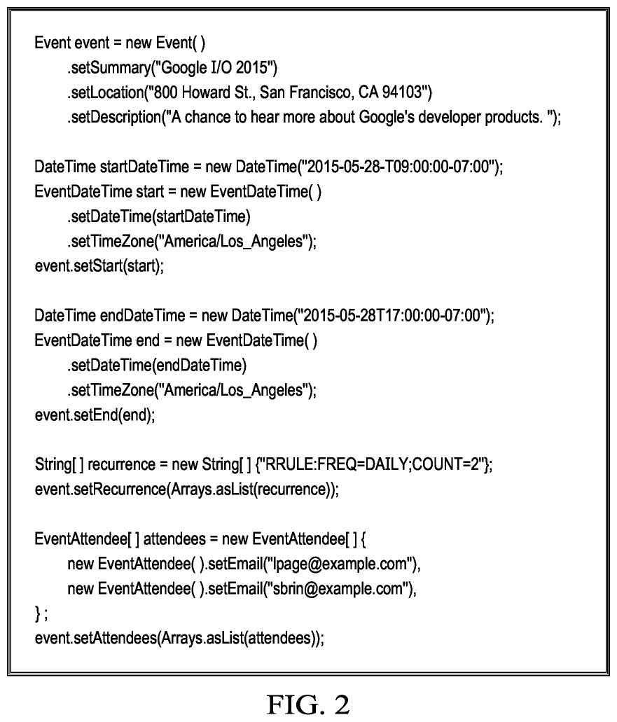

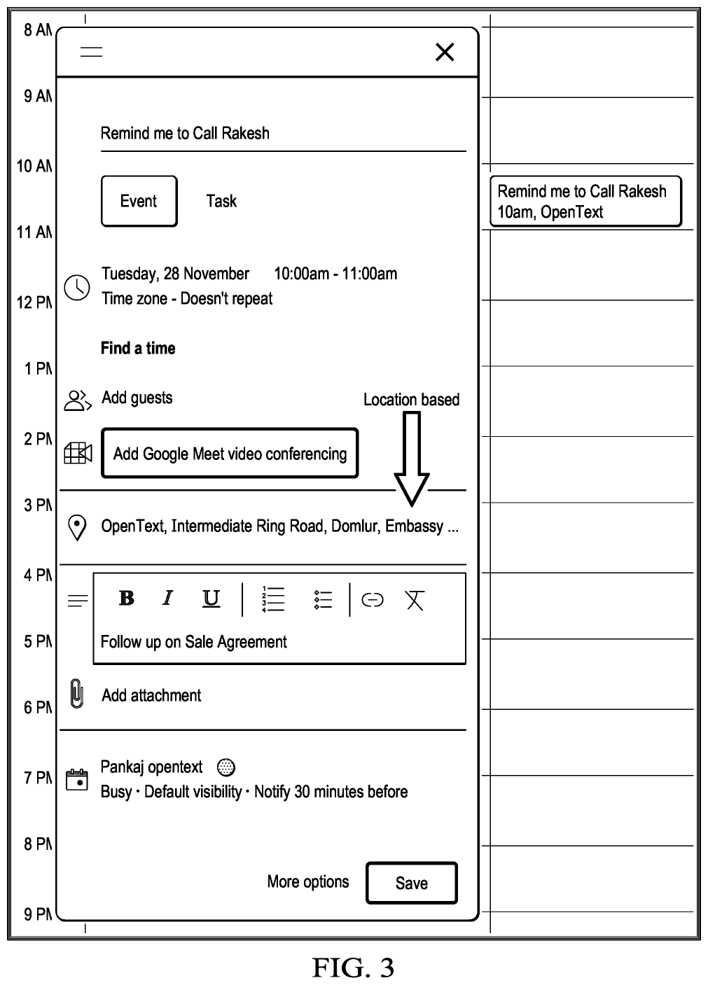

In another embodiment, the reminder may be set in a third party calendaring service such as Google® Calendar using an interface (e.g., an API) offered by that third party calendaring service. An example of such an API is depicted in FIG. 2. A request to the interface for the third party calendaring service may be send from mobile application 130 or mobile application 130 may send a request to interface 108 of ECM platform 100 requesting such a calendar entry be created and ECM platform 100 may access the interface of the third party calendaring service to create such a reminder. The reminder associated with the task 114 in the user's calendar may be set for a specific time or for a specific location (e.g., home, work, the user's office or another location saved in a user's map application on their mobile device). In this manner, location based services may be utilized to determine a user's location and create a reminder in the user's calendar for a user based on such a location. One example of such a location based reminder that may be set for a task is depicted in FIG. 3.

The user may also select an action to call (e.g., conduct a voice conversation with), or message (e.g., sent a text message) to an assigner associated with task 114, or to call or message assigners or assignees of other tasks 114 within the workflow instance 110 associated with the task 114. If such a command is received, mobile application 130 may determine contact information (e.g., a telephone number) for the assigner or assignee associated task 114 selected by the user or other tasks 114 of the workflow instance 110. For example, mobile application 130 may send a request to interface 108 of ECM platform requesting such data (e.g., to determine an assigner of the selected task 114 or assigners or assignees of other tasks 114 of the workflow instance 110 or associated contact information). The mobile application 130 may also access the contact list on the mobile device 132 to determine contact information (e.g., a phone number) for those assigners or assignees). Mobile application 130 can then use the calling or messaging functionality on the mobile device to call or message those assigners or assignees using the determined contact information. This calling or messaging may also be conducted through the car's infotainment system 142.

Mobile application 130 may thus be adapted to facilitate the action selected by the user for the task 114. Moreover, in certain embodiments, mobile application 130 may determine a result of the user's selected action and present the result (e.g., success or failure) to the user (e.g., auditorily) through the car's infotainment system.

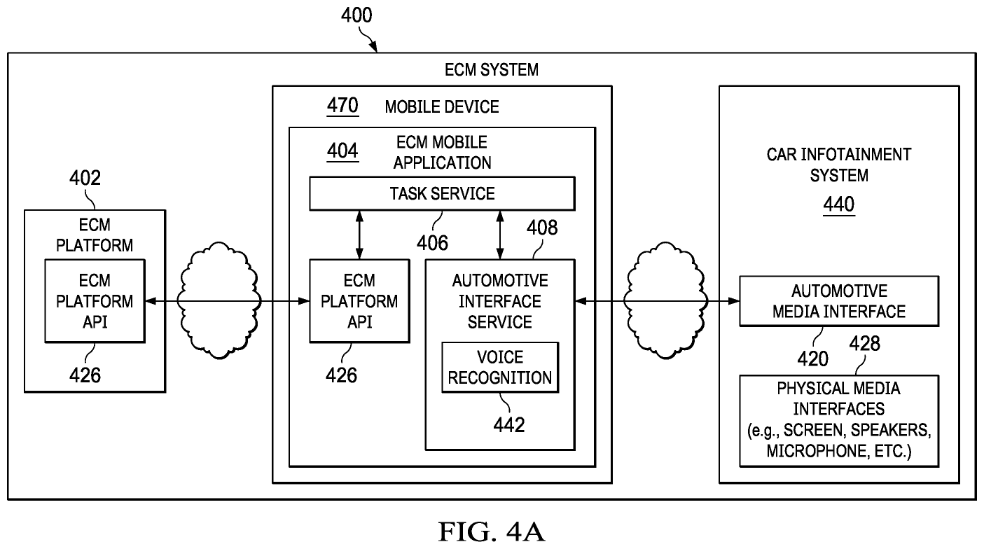

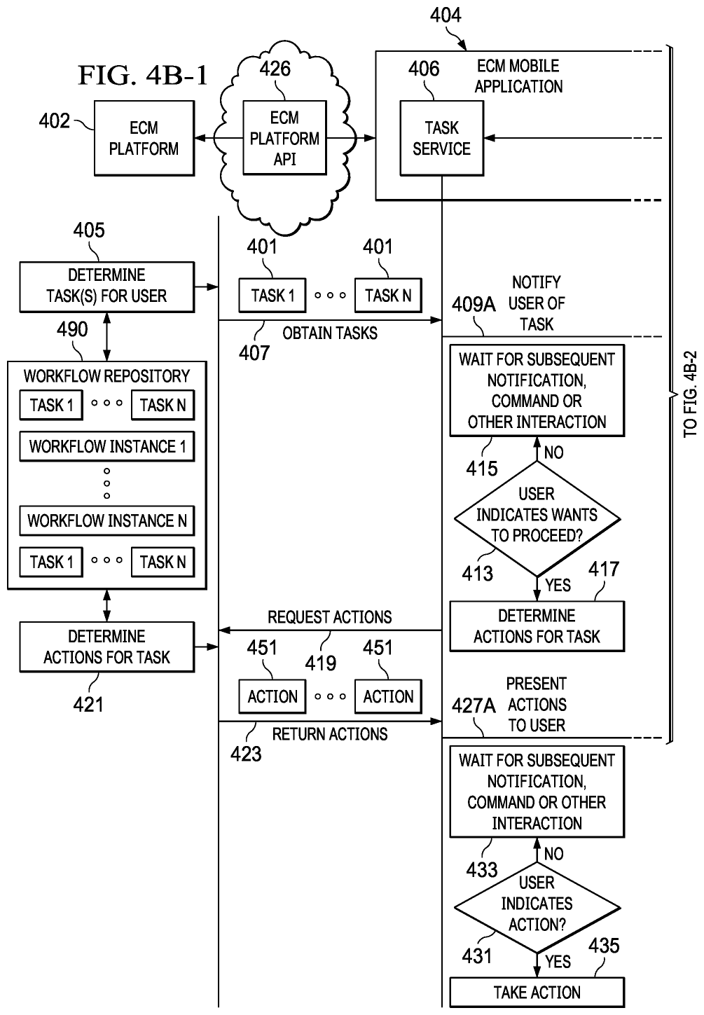

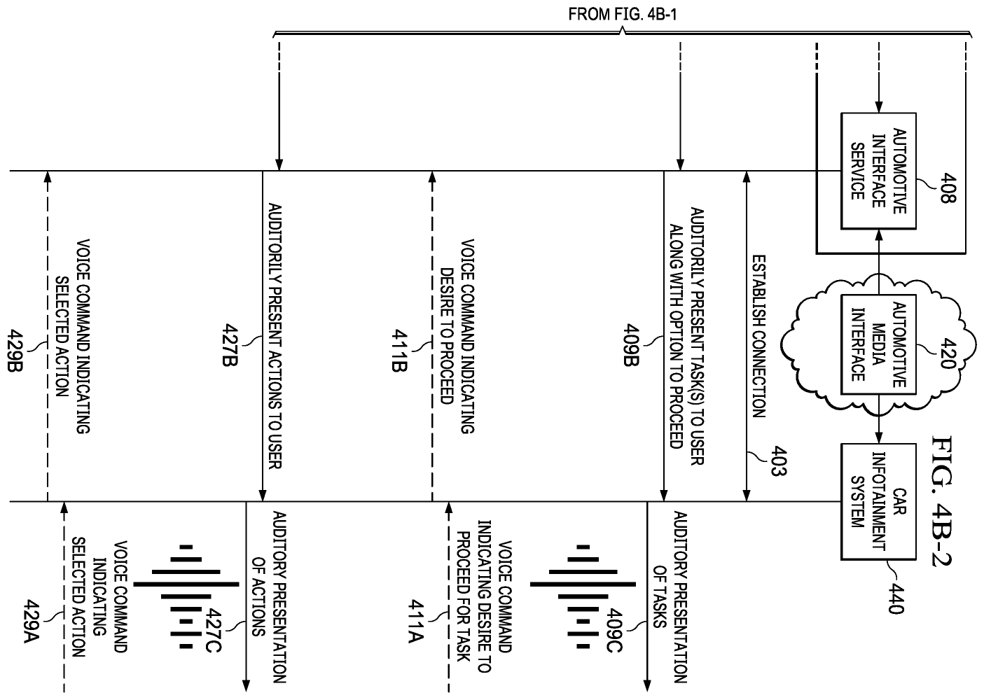

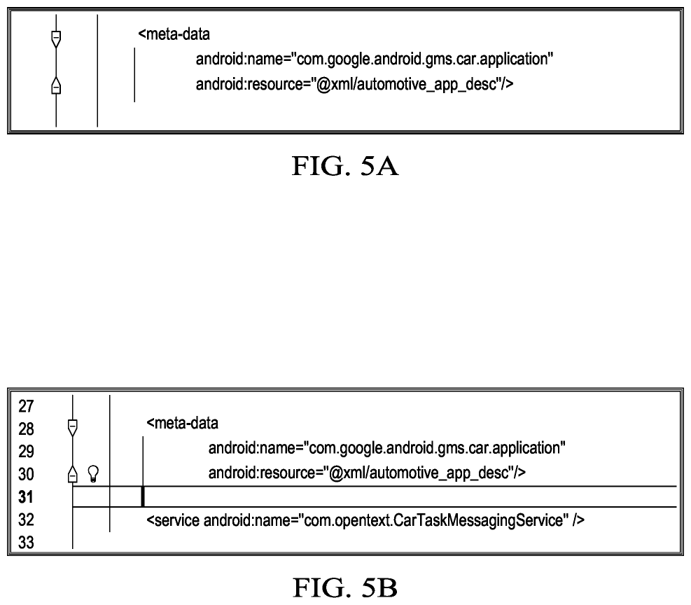

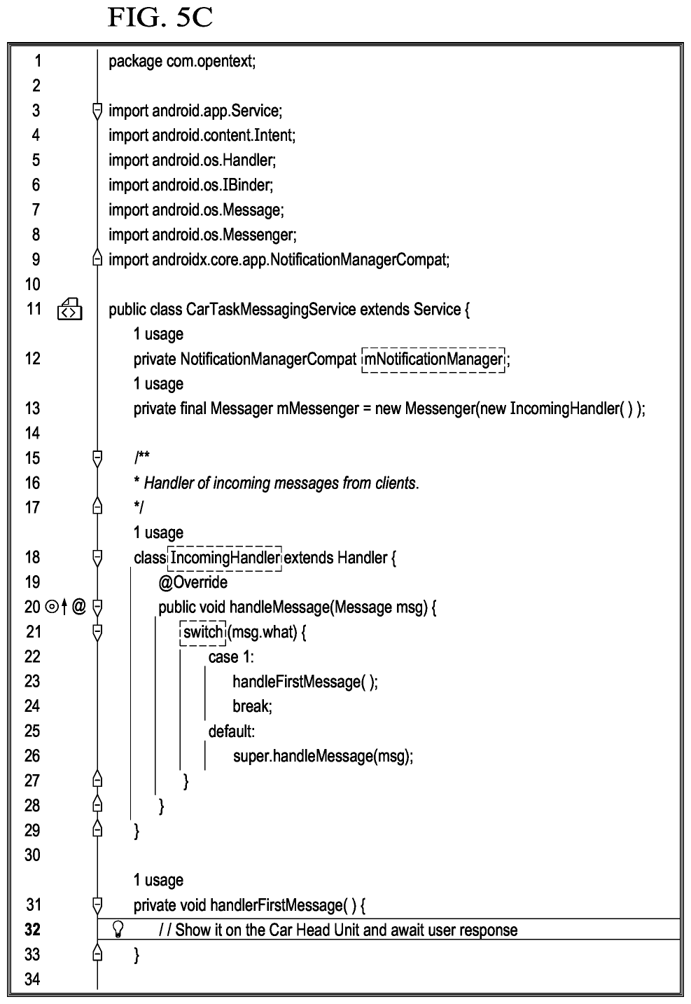

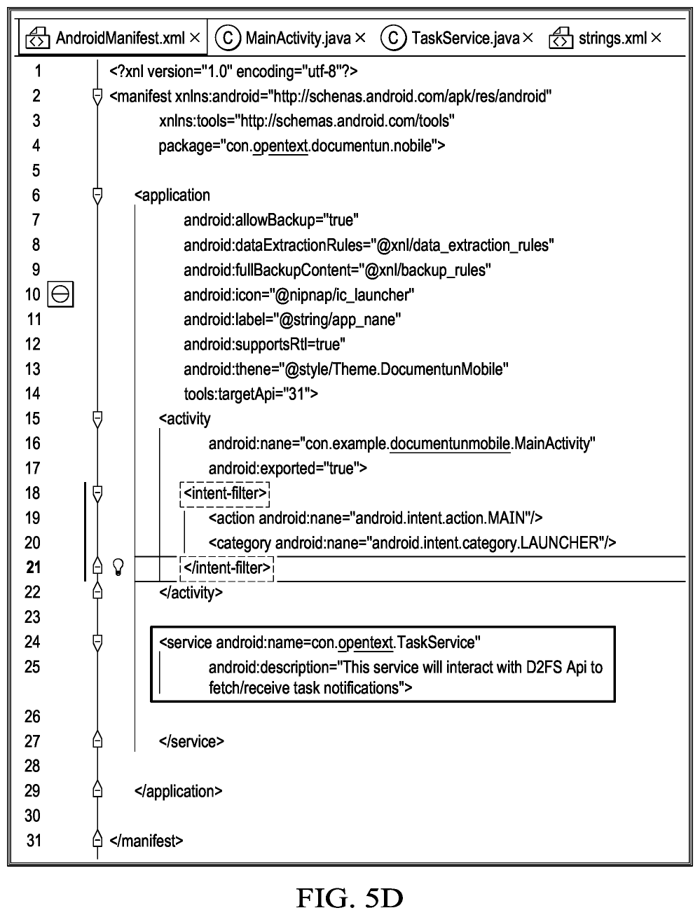

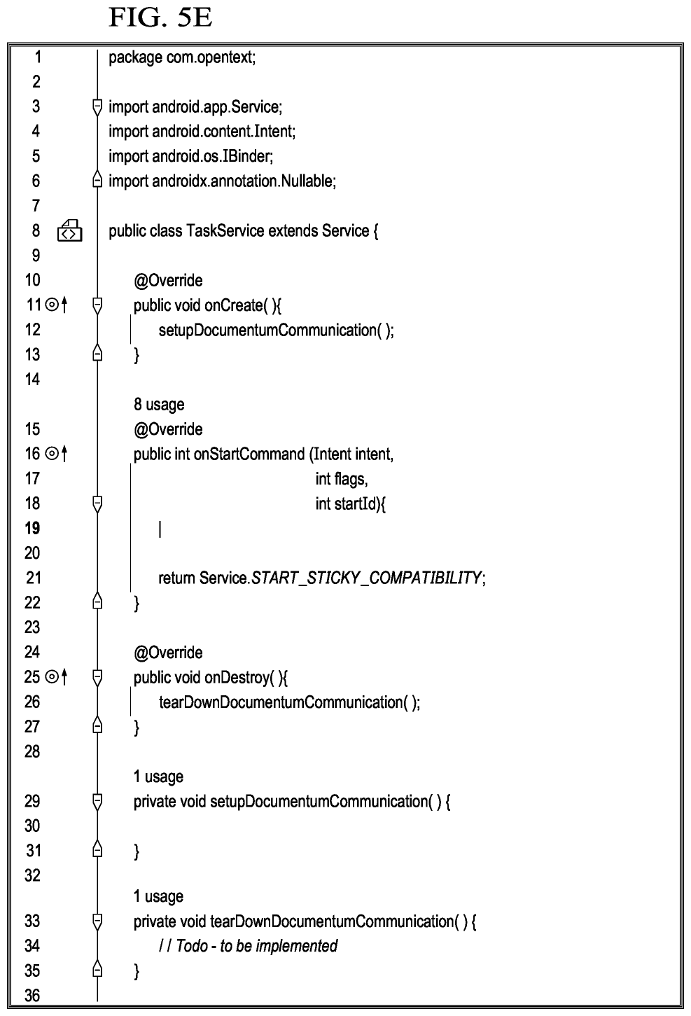

Moving now to FIG. 4A, a block diagram of one embodiment of an architecture for accessing ECM functionality through a mobile application in an automotive media environment is depicted. ECM system 400 includes ECM platform 402 and ECM mobile application 404 executing on a mobile device 470. ECM mobile application 404 is adapted for interaction with a car infotainment system 440 through an automotive media interface 420 offered by the car infotainment system 440 (e.g., Apple CarPlay® or Android Auto®). FIGS. 5A and 5B depict an example for a declaration for such an ECM mobile application given with respect to a mobile application to be utilized on a mobile device running the Android™ operating system and adapted to be utilized with Android Auto®.

Specifically, mobile application 404 may include automotive interface service 408 that may be a messaging service or the like including a messenger and handler for interacting with car infotainment system 440 through automotive media interface 420. Automotive interface service 408 may thus receive commands (e.g., voice commands) issued by a user through the physical media interfaces (e.g., the microphone) of car infotainment system 440 and process these (voice) commands (e.g., using voice recognition module 442 that is present on mobile device 470 or part of mobile application 404) to recognize a command. FIG. 5C includes an example of a definition of such an automotive interface service 408.

Mobile application 404 may include task service 406 adapted to utilize a ECM platform API 426 (which may be a REST API or the like) to interact with ECM platform 402 by sending requests for functionality to an appropriate API as provided by the ECM platform API 426. ECM platform API 426 may include one or more APIs (e.g., URLs, commands, etc.) specific to an automotive context. Thus, task service 406 may utilize such interfaces when operating in such an automotive context. For example, task service 406 may be adapted to fetch tasks or actions from ECM platform 402 and, when needed, to take actions selected by a user (e.g., by calling an appropriate API of ECM platform API 426). In one embodiment, for example, when mobile application is Android application adapted to work with Android Auto®, task service 406 is included in the manifest of mobile application 404 and may be a service invoked by the Android operating system when mobile application 404 is started (e.g., may be called when onCreate( ) is invoked). FIG. 5D depicts one example of an AndroidManifest.xml file including a task service while FIG. 5E includes an example of a definition of task service.

Referring now to FIGS. 4B-1 and 4B-2 (referred to collectively as FIG. 4B), one embodiment of a method of operation of a ECM system in an automotive context to provide workflow functionality to a user through a car's infotainment system using a mobile application on the user's mobile device is depicted. As will be recalled, the ECM system may provide the functionality of a workflow system and be adapted to provide an infrastructure for the set-up, performance, monitoring or tracking of a defined sequence of tasks arranged as a workflow application or process.

The ECM system may thus allow a user to define different workflows that may relate to, for example, different types of content, jobs, or processes. Accordingly, ECM platform 402 may execute workflow instances which are dynamic instances of workflow processes. Each of these workflow instances may be maintained in workflow repository 490 Each workflow instance may comprise a set of tasks 401. Each of the tasks 401 of a workflow instance may be associated with a user to perform that task 401, an action that the user may be required or requested to perform for the task 401, or content associated with that task 401. Tasks 401 of a workflow instance may be dynamically determined, added, or removed based on a state of the workflow instance, the outcome of previous tasks 114, the corresponding workflow template, or other factors.

The ECM system may also include ECM mobile application (or just mobile application) 404 from providing ECM functionality. Such a mobile application 404 may be an application installed on a mobile device such as a smartphone, tablet device, or other mobile computing device. Mobile application 404 can communicate with ECM platform 402 over a network (e.g., a wireless, cellular or other type of network, or a combination of networks) according to ECM platform API 426. Specifically, mobile application 404 may include task service 406 adapted to utilize a ECM platform API 426 (which may be a REST API or the like) to interact with ECM platform 402 by sending requests for functionality to an appropriate API as provided by the ECM platform API 426. Mobile application 404 may also include automotive interface service 408 that may be a messaging service or the like including a messenger and handler for interacting with car infotainment system 440 through automotive media interface 420.

Thus, when a user enters an automotive environment the user's mobile device may establish a connection (STEP 403) to the car's infotainment system 440 through the automotive media interface 420. Tasks 401 for the user for a workflow instance may be determined by the ECM platform (STEP 405). At some point, mobile application 404 may obtain these one or more tasks 401 associated with the user (e.g., assigned to the user) from the ECM platform 402 (STEP 407). Specifically, these tasks 401 may be obtained as a result of a notification sent by ECM platform 402 to the task service 406 of the mobile application 404, or may be a result of a user issuing a voice command requesting a list of tasks through the car's infotainment systems 440, that voice interaction being passed to automotive interface service 408 through automotive media interface 420, and task service 406 requesting tasks 401 for the user through ECM platform API of ECM platform 402.

The tasks 401 can then be auditorily presented to the user by through the interface of mobile application 404 through the car's infotainment system 440 (e.g., one or more of the tasks 401 received by the mobile application 130 may be “read” or “announced” to the user by the interface of the mobile application 404 through the car's infotainment system 404). In particular, when task service 406 receives tasks 401 for the user, the task service 406 may notify the user of the tasks 401 through the automotive interface service 408 (STEP 409A). The automotive interface service 408 can then auditorily present the tasks 401 to the user through car infotainment system 440 over the automotive media interface 420 (STEPS 409B, 409C).

A user may (or may not) respond to the auditory presentation of tasks 401 with a voice command indicating the user desires to proceed (e.g., act) with respect to a task (STEP 411A). Specifically, this voice command may be received through the car's infotainment system 440 and passed to automotive interface service 408 through automotive media interface 420 (STEP 411B), which provided the command to task service 406. Task service 406 can then determine if the user wishes to proceed for a task (STEP 413). This determination may be made based on the reception of command from the user. If no command was received (or a command not to proceed was received) (N branch of STEP 413) the mobile application 404 may await a subsequent command or interaction from a user, or a subsequent notification (STEP 415).

If, however, a command indicating the user wishes to proceed for a task was received, ECM mobile application 404 may process and recognize this voice interaction to act on a task 401 (Y branch of STEP 413). Based on this issued voice command, mobile application 404 may determine actions associated with the task 401 (STEP 417). Specifically, in one embodiment, to determine actions for a task 401, task service 406 may issue a request to ECM platform 402 through ECM platform API 426 for such actions (STEP 419). The interface of ECM platform API 426 selected for the request may be associated with operation of mobile application 404 in an automotive context, such that requests for a particular service at that interface may be associated with (or otherwise determined to be indicators of) operation of the mobile application 404 in an automotive context. The request may, for example, be for actions associated with the task 401 selected by the user and specify (e.g., include an identifier for) a user, a task, a workflow instance, or other pertinent information.

This request can be received according to ECM platform API 426 at the ECM platform 402 and based on this request, the ECM platform 402 can determine actions 451 for that user in association with the task (STEP 421). The determined actions 451 may be based on an action associated with the task 401 (e.g., an action required from a user for the task 401). In particular, the actions 451 determined for task 401 to return to the mobile application 404 may be tailored to the automotive context. For example, if an action associated with a task 401 is an approval, an action 451 determined for the task may be a soft approval for the task. Another action 451 determined for a task in an automotive context may be to add a reminder to revisit the task. Other actions 451 for a task that may be determined based on the mobile applications operation in an automotive context (e.g., as determined based on the interface 426 on which a request was received) may include calling (e.g., conduct a voice conversation with), or messaging (e.g., sending a text message) to an assigner associated with a task or to call or message assigners or assignees of other tasks within the workflow instance. These determined actions 451 for the task can then be returned to the mobile application 404 according to the ECM platform API 426 (STEP 423) (e.g., in a response to the request received from mobile application 404 according to the ECM platform API 426).

The actions 451 can then be auditorily presented to the user by through the interface of mobile application 404 through the car's infotainment system 440 (e.g., one or more of the actions 451 received by the mobile application 404 may be “read” or “announced” to the user by the interface of the mobile application 404 through the car's infotainment system 404). In particular, when task service 406 receives actions 451 for the task 401, the task service 406 may notify the user of the actions 451 through the automotive interface service 408 (STEP 427A). The automotive interface service 408 can then auditorily present the actions 451 to the user through car infotainment system 440 over the automotive media interface 420 (STEPS 427B, 427C).

A user may (or may not) respond to the auditory presentation of actions with a voice command indicating the user selection of a presented action with respect to a task (STEP 429A). Specifically, this voice command selecting an action may be received through the car's infotainment system 440 and passed to automotive interface service 408 through automotive media interface 420 (STEP 429B), which provided the command to task service 406. Task service 406 can then determine if the user has selected an action (STEP 431). This determination may be made based on the reception of a command selecting an action from the user. If no command was received (or a command not to proceed was received) (N branch of STEP 431) the mobile application 404 may await a subsequent command or interaction from a user, or a subsequent notification (STEP 433).

If, however, a command indicating the user wishes to proceed for an action was received, ECM mobile application 404 may process and recognize this voice interaction to take an action (Y branch of STEP 431) and take such an action (STEP 435). For example, taking such an action may include sending a request to ECM platform 402 associated with the user selected action.

For example, if a user selects a soft approval action, the ECM mobile application 404 may send a request to an interface defined by ECM platform API 426 associated with a soft approval indicating a soft approval of the task. This request may, for example, specify (e.g., include an identifier for) the user, the task, the workflow instance, or other pertinent information. When ECM platform 402 receives such a request for a soft approval, ECM platform 402 may register the soft approval with the corresponding task and user. Accordingly, a workflow instance associated with a task that was soft approved by the user may be allowed to proceed to a subsequent stage.

The user may also select an action to add a reminder to revisit the task. In response to receiving a command selecting such an action, mobile application 404 may access a calendaring application on the mobile device and store a reminder (e.g., a calendar entry) specifying the task in the calendar. The reminder may include a link to the task (e.g., at the ECM platform 402) or content related to the task. The mobile application may also send a request to an interface defined by ECM platform API 426 associated with setting a reminder for a user to store such a reminder in a calendar of the user associated with the ECM platform 402. In another embodiment, the reminder may be set in a third party calendaring service such as Google® Calendar using an interface (e.g., an API) offered by that third party calendaring service.

The user may also select an action to call (e.g., conduct a voice conversation with), or message (e.g., sent a text message) to an assigner associated with a task, or to call or message assigners or assignees of other tasks. If such a command is received, mobile application 404 may determine contact information (e.g., a telephone number) for an assigner or assignee of a task. Mobile application 404 can then use the calling or messaging functionality on the mobile device to call or message those assigners or assignees using the determined contact information. This calling or messaging may also be conducted through the car's infotainment system 440.

Various types of computing systems may be used for implementing embodiments as disclosed herein. These computing systems may include one or more central processing units (CPU) or processors coupled to one or more user input/output (I/O) devices and memory devices. Examples of I/O devices may include, but are not limited to, keyboards, displays, monitors, touch screens, printers, electronic pointing devices such as mice, trackballs, styluses, touch pads, or the like. Examples of memory devices may include, but are not limited to, hard drives (HDs), magnetic disk drives, optical disk drives, magnetic cassettes, tape drives, flash memory, random access memories (RAMs), read-only memories (ROMs), smart cards, etc. Computing systems can be coupled to a display, information device and various peripheral devices, such as printers, plotters, speakers, etc. through I/O devices. A computing system may also be coupled to external computers or other devices through network interfaces, wireless transceivers, or other means that is coupled to a network such as a local area network (LAN), wide area network (WAN), a cellular network or the Internet.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer, or a special purpose computer or data processor that is specifically programmed, configured, or constructed to perform the functions described in detail herein. The invention can also be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer readable medium, hardware circuitry or the like, or any combination and that may be translatable by one or more server machines. Examples of a non-transitory computer readable medium are provided below in this disclosure.

Suitable computer-executable instructions may reside on a non-transitory computer readable medium (e.g., ROM, RAM, and/or HD), hardware circuitry or the like, or any combination thereof. Within this disclosure, the term “non-transitory computer readable medium” is not limited to ROM, RAM, and HD and can include any type of data storage medium that can be read by a processor. Examples of non-transitory computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps, and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nano-engineered systems, components, and mechanisms may be used. In general, the functions of the invention can be achieved by any means as is known in the art. For example, distributed, or networked systems, components, and circuits can be used.

In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory. Such a computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any hardware system, mechanism or component that processes data, signals or other information. A processor can include a system with a central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited to only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the accompanying appendices, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein and in the accompanying appendices, the meaning of “in” includes “in” and “on” unless the context clearly dictates otherwise.

Although the foregoing specification describes specific embodiments, numerous changes in the details of the embodiments disclosed herein and additional embodiments will be apparent to, and may be made by, persons of ordinary skill in the art having reference to this disclosure. In this context, the specification and figures are to be regarded in an illustrative rather than a restrictive sense, and all such modifications are intended to be included within the scope of this disclosure. The scope of the present disclosure should be determined by the following claims and their legal equivalents.

What is claimed is:

1. A method, comprising:
determining one or more workflow tasks associated with a user, each of the workflow tasks associated with a workflow instance executing at an enterprise content management (ECM) platform;
obtaining the one or more workflow tasks associated the user at an ECM mobile application executing on a mobile device associated with the user, wherein the ECM mobile application is operating in an automotive context and is connected to a car infotainment system through an automotive media interface; and
based on the operation of the ECM mobile application in the automotive context, presenting the one or more workflow tasks through the car infotainment system using the automotive media interface.

2. The method of claim 1, wherein the presentation of the one or more workflow tasks is an auditory presentation through the car infotainment system.

3. The method of claim 1, further comprising:
receiving, at the ECM mobile application, a command associated with a task through the car infotainment system over the automotive media interface;
determining the command is an indication to proceed with the workflow task;
based on the command, determining a set of actions associated with the workflow task; and
presenting the set of actions for the workflow task through the car infotainment system using the automotive media interface.

4. The method of claim 3, wherein the command is a voice command.

5. The method of claim 3, wherein at least one of the set of actions is a first action specific to the automotive context.

6. The method of claim 5, wherein determining the set of actions comprises:
sending, based on the first command, a request from the ECM mobile application to the ECM platform at an interface of the ECM platform associated with the automotive context; and
receiving the set of actions from the ECM platform in response to the request, wherein the set of actions is determined at the ECM platform based on the operation of the mobile application in the automotive context and a second action associated with the workflow task at the ECM platform.

7. The method of claim 6, wherein the second action associated with the workflow task at the ECM platform is an approval associated with content and the first action comprises a soft approval allowing the workflow instance to proceed to a subsequent task at the ECM platform without the user approving associated content.

8. A system, comprising:
a mobile device, comprising:
a processor;
a non-transitory computer-readable medium comprising instructions for:
obtaining the one or more workflow tasks associated a user at an ECM mobile application executing on a mobile device associated with the user, wherein the ECM mobile application is operating in an automotive context and is connected to a car infotainment system through an automotive media interface and the one or more workflow tasks are associated with a user and a workflow instance executing at an ECM platform; and
based on the operation of the ECM mobile application in the automotive context, presenting the one or more workflow tasks through the car infotainment system using the automotive media interface.

9. The system of claim 8, wherein the presentation of the one or more workflow tasks is an auditory presentation through the car infotainment system.

10. The system of claim 8, further comprising instructions for:
receiving, at the ECM mobile application, a command associated with a task through the car infotainment system over the automotive media interface;
determining the command is an indication to proceed with the workflow task;
based on the command, determining a set of actions associated with the workflow task; and
presenting the set of actions for the workflow task through the car infotainment system using the automotive media interface.

11. The system of claim 10, wherein the command is a voice command.

12. The system of claim 10, wherein at least one of the set of actions is a first action specific to the automotive context.

13. The system of claim 12, wherein determining the set of actions comprises:
sending, based on the first command, a request from the ECM mobile application to the ECM platform at an interface of the ECM platform associated with the automotive context; and
receiving the set of actions from the ECM platform in response to the request, wherein the set of actions is determined at the ECM platform based on the operation of the mobile application in the automotive context and a second action associated with the workflow task at the ECM platform.

14. The system of claim 13, wherein the second action associated with the workflow task at the ECM platform is an approval associated with content and the first action comprises a soft approval allowing a workflow instance to proceed to a subsequent task at the ECM platform without the user approving associated content.

15. A non-transitory computer-readable medium, storing instructions for:
obtaining the one or more workflow tasks associated a user at an ECM mobile application executing on a mobile device associated with the user, wherein the ECM mobile application is operating in an automotive context and is connected to a car infotainment system through an automotive media interface and the one or more workflow tasks are associated with a user and a workflow instance executing at an ECM platform; and
based on the operation of the ECM mobile application in the automotive context, presenting the one or more workflow tasks through the car infotainment system using the automotive media interface.

16. The non-transitory computer-readable medium of claim 15, wherein the presentation of the one or more workflow tasks is an auditory presentation through the car infotainment system.

17. The non-transitory computer-readable medium of claim 15, further comprising instructions for:
receiving, at the ECM mobile application, a command associated with a task through the car infotainment system over the automotive media interface;
determining the command is an indication to proceed with the workflow task;
based on the command, determining a set of actions associated with the workflow task; and
presenting the set of actions for the workflow task through the car infotainment system using the automotive media interface.

18. The non-transitory computer-readable medium of claim 17, wherein the command is a voice command.

19. The non-transitory computer-readable medium of claim 17, wherein at least one of the set of actions is a first action specific to the automotive context.

20. The non-transitory computer-readable medium of claim 19, wherein determining the set of actions comprises:
sending, based on the first command, a request from the ECM mobile application to the ECM platform at an interface of the ECM platform associated with the automotive context; and
receiving the set of actions from the ECM platform in response to the request, wherein the set of actions is determined at the ECM platform based on the operation of the mobile application in the automotive context and a second action associated with the workflow task at the ECM platform.

21. The non-transitory computer-readable medium of claim 20, wherein the second action associated with the workflow task at the ECM platform is an approval associated with content and the first action comprises a soft approval allowing a workflow instance to proceed to a subsequent task at the ECM platform without the user approving associated content.
